(19) United States
(12) Patent Application Publication
(10) Pub. No.: US 2017/0351822 A1
(43) Pub. Date: Dec. 7, 2017

(54) METHOD AND SYSTEM FOR ANALYZING AND DISPLAYING OPTIMIZATION OF MEDICAL RESOURCE UTILIZATION

(71) Applicant: hMetrix LLC, Bala Cynwyd, PA (US)

(72) Inventors: George CHALISSERY, Bala Cynwyd, PA (US); Verghese VERGHESE, Bala Cynwyd, PA (US); Jineesh Kachira JAMES, Bala Cynwyd, PA (US); Sindhumol SABU, Bala Cynwyd, PA (US); Afsal Tharupeedikayil ABDULKHADER, Bala Cynwyd, PA (US); Udaya ADUKKADUKKAM, Bala Cynwyd, PA (US); Sreekumar Mullasseril SASIDHARAN, Bala Cynwyd, PA (US)

(21) Appl. No.: 15/175,969

(22) Filed: Jun. 7, 2016

(51) Int. Cl. G06F 19/00; G06F 17/30

(52) U.S. Cl. CPC G06F 19/328; G06F 19/345; G06F 17/30321; G06F 17/30598; G06F 19/325

(57) ABSTRACT

A computer implemented method and system for optimization of medical resource utilization within a set of physicians in order to calculate a potential cost savings opportunity is described. Input classified discharge data directed to cost information for service items grouped by a Diagnosis Related Group (DRG) is assigned to a physician which was most responsible for the resource utilization in treating the patient while the patient was hospitalized. For each DRG in the classified data, the responsible physicians are dynamically clustered based on resource utilization to identify the factors that are consistently different across the clustered physicians as a difference index value. The difference index value can be analyzed for determining potential cost savings opportunities. An interactive user interface can be used for entering discharge data, dynamically displaying resource utilization by the difference index value and potential cost savings opportunities.

### BACKGROUND OF THE INVENTION

### Field of the Invention

The present invention relates to a method and system for evaluating data of medical resource utilization by physicians to determine the potential for cost savings and visualizing the resultant data in an interactive user interface.

### Description of Related Art

Systems and methods have been proposed for assessing and optimizing healthcare administration in order to try to conserve associated costs. U.S. Pat. No. 8,285,585 discloses an automated system and method for evaluating the performance of individuals or entities employed by an organization. A composite physician may be generated from system-wide and/or state-wide healthcare data as a benchmark against which a particular physician is profiled according to industry-standard measurements. The composite physician enables a comprehensive “apple to apple” comparison with the particular physician, giving meaning to and facilitating the usefulness of performance evaluation results. Peer average calculations can be adjusted based on a set of filtering criteria to enhance the peer-profiled performance evaluation of the physician. Only cases that match the physician's profile in this measure are used to evaluate performance.

U.S. Pat. No. 8,630,871 discloses a method for generating healthcare provider quality rating data includes grouping claim records into one or more claim groups, assigning each claim group to a responsible provider, assessing the claim records in each claim group using guidelines for the particular disease or condition, and generating a compliance score for the claim group, wherein the compliance score indicates the extent to which the claim records in the claim group match the guidelines, and generating normalized provider quality rating data. A method for generating healthcare provider cost rating data includes grouping claim records into one or more claim groups, assigning each claim group to a responsible provider, calculating the total cost of each claim group, aggregating the total cost for each claim group, and comparing the total aggregate cost of each claim group assigned to each provider to an expected cost value.

U.S. Patent Application Publication No. 2014/0324472 discloses systems and methods that facilitate extraction and analysis of patient encounters from one or more healthcare related information systems. The system includes a reception component configured to receive information from a plurality of sources regarding courses of care of a plurality of patients, including information identifying activities associated with the courses of care, timing of the activities, resources associated with the activities, and caregiver personal associated with the activities. The system further includes an indexing component configured to generate an index that relates aspects of the information, a filter component configured to employ the index to identify a subset of the information related to a subset of the courses of care for patients associated with a similar medical condition, and an analysis component configured to compare aspects of the subset of the information to identify variance in the subset of the courses of care.

U.S. Patent Application Publication No. 2016/0034648 teaches a system and method for enabling physicians and hospitals to objectively reduce clinical and operational variations, which act to improve the quality and cost efficiencies of care. Clinical variation is quantified between each physician's best-demonstrated use of specific medical resources and his/her inefficient use of those resources. With his or her own variations quantified, the doctor then compares the variations to those of peer physicians in the hospital who manage similar patients.

It is desirable to provide a method and system for evaluating data of medical resource utilization by physicians and interactively displaying potential cost savings based on the evaluated data.

### SUMMARY OF THE INVENTION

The present invention relates to a computer implemented method and system for optimization of medical resource utilization within a set of physicians in order to calculate a potential cost savings opportunity. An inpatient discharge, referred to as discharge, is a patient who was formally admitted to a hospital as an inpatient for observation, diagnosis, or treatment, with the expectation of remaining overnight or longer, and who is discharged under one of the following circumstances: (a) is formally discharged from care of the hospital and leaves the hospital, (b) transfers within the hospital from one type of care to another type of care, or (c) has died. In the method, discharge data of a plurality of discharges from one or more hospitals directed to cost information for service items is obtained and classified, such as by grouping discharges using Diagnosis Related Group (DRG). The classified discharge data is assigned to a physician which was most responsible for the resource utilization in treating the patient while the patient was hospitalized. For each DRG in the classified data, the responsible physicians (RPs) are dynamically clustered based on resource utilization to identify the factors that are consistently different across the clustered physicians, referred to as a difference index value. From the difference index value, the resource dimensions with the highest difference index value can be selected for optimizing resource utilization. A potential cost savings opportunity can be computed as a variance between the actual cost and the optimal cost based on the optimization of the resource utilization. An interactive user interface can be used for reviewing discharge data, dynamically displaying resource utilization by the difference index value and potential cost savings opportunities.

The invention will be more fully described by reference to the following drawings.

### BRIEF DESCRIPTION OF THE DRAWINGS

FIG. 1 is a flow diagram of a method of evaluating data of medical resource utilization by physicians and interactively displaying potential cost savings based on the evaluated data.

FIG. 2 is a flow diagram of a method for assigning Diagnosis Related Group (DRG) to discharges and data preparation of the assigned grouping.

FIG. 3 is a flow diagram of a method of clustering physicians.

FIG. 4 is a flow diagram of a method for calculating the difference index for each utilization dimension within one DRG.

FIG. 5 is a flow diagram of a method for calculating the potential saving opportunity.

FIG. 6 depicts a system diagram outlining the physical systems relationships between a medical facility data system, a data center and an end user.

FIG. 7 is an example of an interactive user dashboard displaying potential cost savings based on the evaluated data.

FIG. 8 is an example of different reports displaying savings opportunities by the top APR DRGs and by the top physicians based on the evaluated data.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

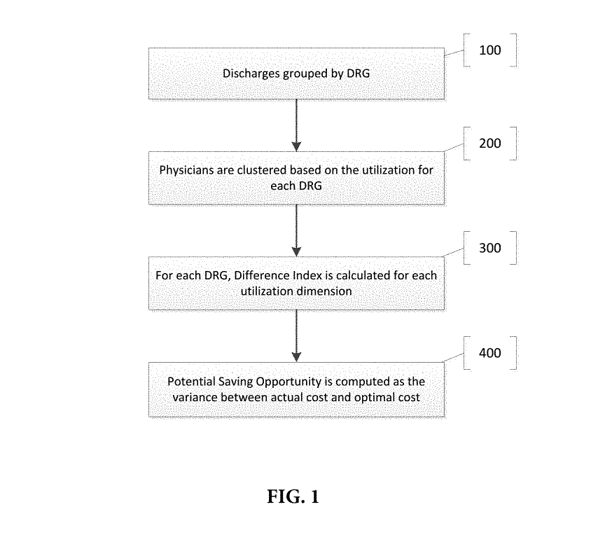

FIG. 1 is a flow diagram a method of evaluating data of medical resource utilization by physicians and interactively displaying potential cost savings based on the evaluated data. In block 100, discharge data is processed.

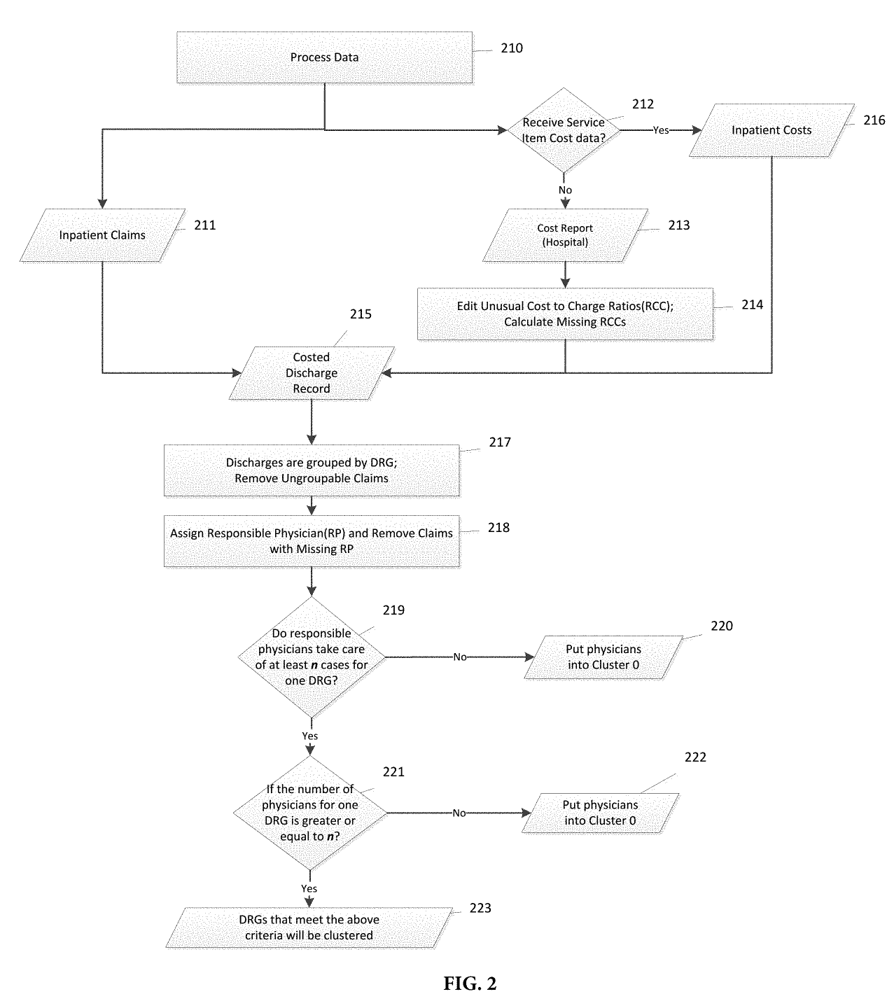

FIG. 2 is a flow diagram of an implementation of block 100 including a method for assigning Diagnosis Related Group (DRG) to discharges and steps of data preparation. In block 210, medical data is obtained. The medical data can be all inpatient data for one hospital or a plurality of hospitals in a particular grouping. For example, the inpatient data grouping can relate to all inpatient data of all hospitals in one healthcare system. Alternatively, the inpatient data grouping can relate to inpatient data of hospitals in a portion of a state, such as hospitals in a particular county or a selected group of participating hospitals.

In block 211, inpatient claim data is determined from inpatient claim information of the obtained medical data which is generated during inpatient stays at hospitals or the like. The inpatient claim information includes all claims associated with the patient's stay in the hospital, such as for example room and board, prescription drug claims, medical tests and the like. Inpatient claim information can be derived from claim information entered on conventional forms such as the uniform/universal billing Form 8371 or Form CMS-1450, also known as UB-04, which is the official HCFA/CMS form used by hospitals and health care centers when submitting bills to Medicare and 3^{rd}-party payors for reimbursement for health services provided to patients covered or any other similar methods of collecting claim information that are conventionally used by hospitals.

In block 212 it is determined if the inpatient claim data contains cost information at a service item level from a hospital. A service item can be an item used as part of the care delivered for each discharge at the hospital. The service item can include one or more items used in different aspects or revenue centers of the hospital. Examples of service items include individual medical supply items, surgical supply items, drugs, laboratory, radiology, operating room and room & board items. If the inpatient claim data contains cost information at a service item level from a hospital, then block 216 is implemented. If the inpatient claim data does not contains cost information at a service item level from a hospital, then block 213 is implemented. In block 213, an inpatient cost to charge ratio data is determined from cost reports, such as the Medicare hospital cost reports. In block 214, the cost report data is edited to exclude or correct outlier cost to charge ratios (RCC) and a missing RCC ratio is calculated using a statistical method. In one embodiment, a regression model is run using the statewide data to come up with the RCC ratio for the cost centers without RCC ratio. In block 215, the costs incurred per inpatient claim are determined from the discharge claim information of block 216 and the cost report data to form a costed discharge record. For example, the costs can be determined by industry standard cost accounting techniques, such as hospital-specific, cost-center-specific and ratio of costs to charges.

In block 217, the costed discharge record along with the inpatient services provided for them are classified using groupings of Diagnosis Related Group (DRG)s. The classification of the diagnosis related groups can be adjusted for severity of illness. In the adjustment for severity of illness, the DRGs can be further defined by describing each diagnosis in terms of four levels of medical severity referred to as refinement classes. For example, refinement classes can include whether the DRG is a grouping of medical or surgical diagnoses, the patient's sex, the patient's age, whether the patient died within two days of admission, and whether the patient was discharged against medical advice. For example, for a hip replacement surgery, an obese 70 year old patient with diabetes and a liver transplant is likely to place a greater drain on resources versus a fit 70 year old patient looking for a hip replacement. Even though these discharges fall into the same DRG, the cost attributed to the treatment of each can be more accurately analyzed due to the refining of the DRG. In this manner, refined DRGs group discharges according to resource intensity, and thus allow more accurate comparisons. For example, block 217 can be implemented for classifying Medicare fee-for-service inpatient stays by determining ALL PATIENT REFINED DIAGNOSIS RELATED GROUPS (APR DRGs) using Averill, R. F. et al. Definition Manual, 3M Health Information System, Wallingford, Conn., 1988, hereby incorporated by reference into this application and as described in U.S. Pat. No. 5,652,842 hereby incorporated in its entirety by reference into this application, can be used to determine classified diagnosis related groups. It will be appreciated that in the present disclosure, classified DRGs are referred to as APR DRG and that APR DRGs can refer to classified DRGs which can be determined by other discharge classification methods. Claim records with Ungroupable APR DRGs are removed from further analysis.

In block 218, the classified services provided to a discharge are assigned to a responsible physician (RP). A responsible physician (RP) is defined as the physician most responsible for resource utilization while the patient is hospitalized. In the APRDRG grouping, all inpatient facility claims are classified as either medical or surgical. The following two physician fields on the conventional uniform/universal billing Form 8371 or Form CMS-1450, also known as UB-04, can be used in the responsible physician (RP) determination process: Attending Physician referenced by Form Locator 76 and other physician referenced by Form Locator 77. For example, the operating physician can be the surgeon.

An example method for the determination of the responsible physician (RP) is as follows:

1) If the APR DRG is surgical, the responsible physician (RP) is the first entry in the other physician location. If the other physician location is empty, the attending physician is used;

2) If the APR DRG is not surgical, the responsible physician (RP) is the attending physician;

3) If the attending physician is empty, then no responsible physician (RP) is assigned. These claims records are removed from further analysis.

In block 219, it is determined if the responsible physician (RP) takes care of a threshold number of cases for the same DRG. Accordingly, if the number of cases that the responsible physician (RP) takes care for the same DRG is less than the threshold minimum cases number (nc), the responsible physician RP is assigned to Cluster 0 in block 220.

In block 221, it is determined if a minimum number of responsible physician (RP) take care of one DRG. Accordingly, if the number of responsible physicians (RPs) taking care of one DRG is less than the threshold minimum physicians number (np), the DRG is assigned to Cluster 0 in block 222. In block 223, the dataset of determined DRGs meeting the criteria is created.

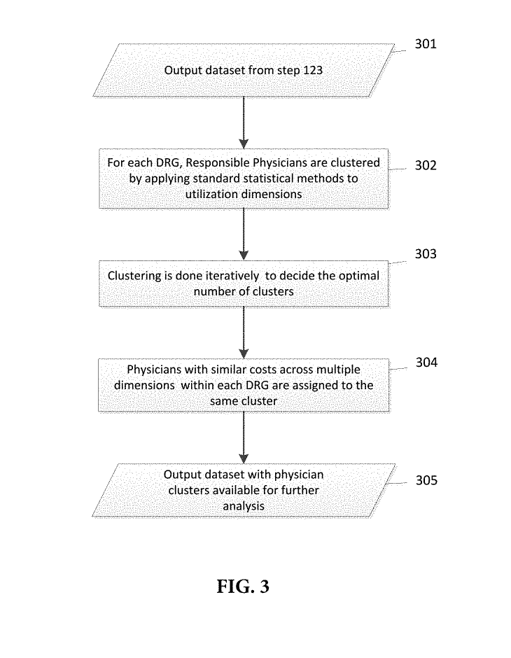

Referring to FIG. 1, in block 200 physicians are clustered using the dataset of determined DRGs meeting the criteria. FIG. 3 is a flow diagram of an implementation of block 200 for a method of clustering physicians.

In block 301, the dataset of determined DRGs meeting the criteria from block 223 is input In block 302, for each DRG, responsible physicians (RPs) are clustered by applying conventional statistical methods, such as for example a k-means method, to utilization dimensions of the DRG. Utilization dimensions refer to the broad categorization of the items utilized by physicians to treat patients. For example, medical/surgical supplies, drugs, labs and radiology, etc. All resources of the DRG are considered when performing the clustering. For example, physicians with discharges in the same DRG who are identical in room and board utilization, but different in the use of drugs will be placed in different clusters. Physicians within a determined cluster are similar to each other, while physicians in different clusters are different from each other.

In block 303, for each DRG, clustering is done iteratively to decide the optimal number of clusters based on the overall R-Square value. The number of clusters is typically limited to 2-5. For different APR DRGs, the number of clusters can be different. For example, for APR DRG 720, it can result to have 3 clusters as the optimal number of clusters while for APR DRG 140, it can result to have 4 clusters. A physician can only belong to one cluster. As a result, responsible physicians RPs with similar costs across multiple dimensions within each DRG are assigned to the same cluster in block 304. In block 305, the data set of responsible physicians RP (RP) clusters is created

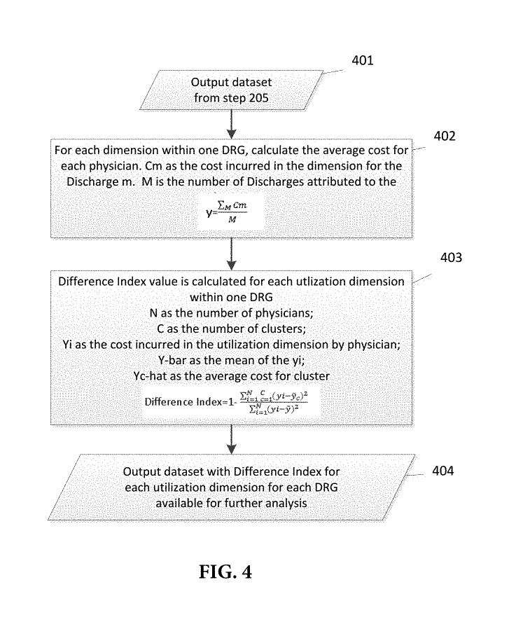

Referring to FIG. 1, in block 300 the dataset of responsible physicians (RP) clusters is used to calculate a difference index for each utilization dimension for each DRG. FIG. 4 is a flow diagram of an implementation of block 300 for calculating the difference index for each utilization dimension within one DRG.

In block 401, the dataset of responsible physicians (RP) clusters determined from block 305 is input

In block 402, for each dimension within one DRG, the average cost for each physician is calculated. It is calculated as the average cost per discharge across all discharges within each APR DRG that is attributed to the responsible physician (RP). Cm is the cost incurred in the dimension for the discharge m. M is the number of discharges attributed to the physician. At step 402, for each dimension within one DRG, for each of the responsible physicians (RP), average cost (y) is calculated where

$$y = \text{?}$$

$$\text{?} \text{indicates text missing or illegible when filed}$$

In block 403, a Difference Index value is calculated for each utilization dimension within one DRG. N is the number of RPs for that DRG. C is the number of clusters. Within one DRG, for one utilization dimension, Yi is the average cost for a responsible physician (RP) i calculated in step 402; Y-bar is the mean of the average cost among all the physicians for the DRG; Yc-hat is the average physician cost in cluster c. At this step, the Difference Index is calculated where

$$Difference Index = 1 - \text{?}$$

$$\text{?} \text{indicates text missing or illegible when filed}$$

In block 404, the data set of a Difference Index for each utilization dimension for each DRG is created

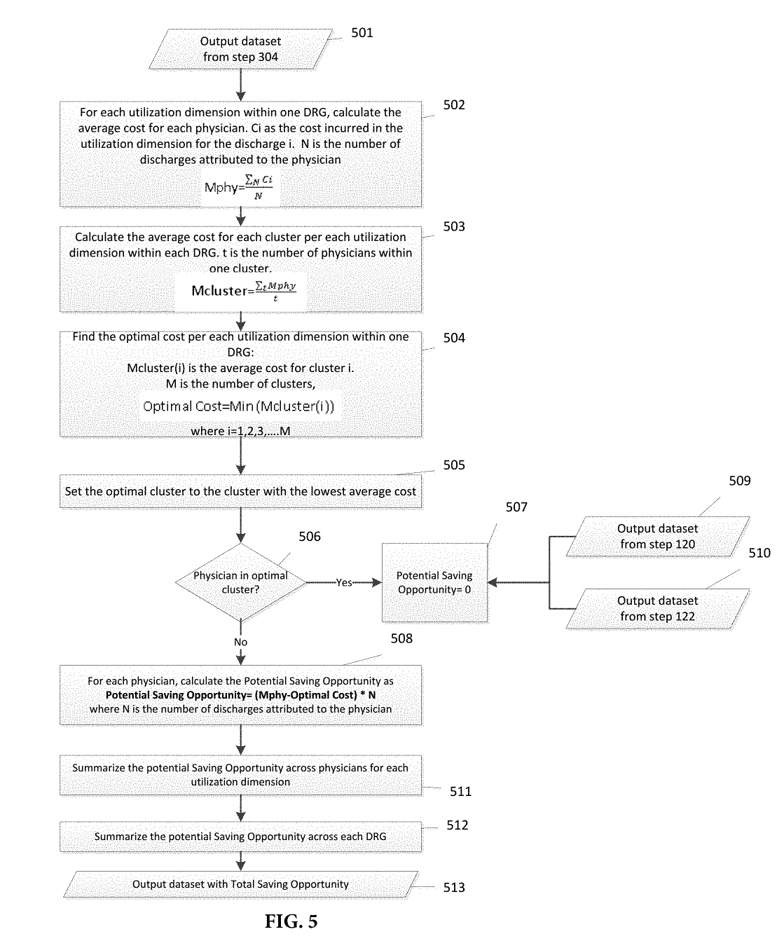

Referring to FIG. 1, in block 400 the data sets of average actual discharge cost by a physician and the physician clustering result are used to determine a potential cost savings opportunity. Potential cost savings opportunity is the variance between the actual discharge cost and the optimal discharge cost. FIG. 5 is a flow diagram of an implementation of block 400 for calculating the potential cost saving opportunity.

In block 501, the data set of a Difference Index for each utilization dimension for each DRG is input.

In block 502, for each dimension within one DRG, the average cost for each physician is calculated. It is calculated as the average cost per discharge across all discharges within each APR DRG that is attributed to the responsible physician (RP). Ci is the cost incurred in the dimension for the Discharge i. N is the number of discharges attributed to the physician. At this step, for each dimension within one DRG, for each RP, average cost (Mphy) is calculated where

$$Mphy = \text{?}$$

$$\text{?} \text{indicates text missing or illegible when filed}$$

In block 503, the average cost for each cluster per each dimension within each DRG is calculated. It is calculated as the mean of the average cost among all the physicians in the cluster. t is set as the number of physicians within one cluster. At this step, average cost for each cluster is calculated where

$$Mcluster = \text{?}$$

$$\text{?} \text{indicates text missing or illegible when filed}$$

In block 504, the optimal cost per each dimension within one DRG is found. It is the minimum average cost among all the clusters. Mcluster(i) is set as the average cost for cluster i calculated in step 503. M is the number of clusters. At this step, the optimal cost is calculated where

Optimal Cost=Min(Mcluster(i))i=1,2,3 . . . M

In block 505, within one DRG, the optimal cluster is set to the cluster with the minimum average cost among clusters which is found as step 504.

In block 506, within one DRG, in order to calculate the potential saving opportunity for each of the responsible physician (RP), first determine if the responsible physician (RP) is in the optimal cluster which was found in step 505. Accordingly, if the responsible physician (RP) is found in the optimal cluster, then set the potential saving opportunity for this responsible physician (RP) as 0 in block 507. Otherwise, in block 508, set the potential saving opportunity for this responsible physician (RP) as the variance between the Actual Cost and the Optimal Cost calculated in block 504. The Potential Saving Opportunity is calculated in Step 508 as

Potential Saving Opportunity=(Mphy−Optimal Cost)*N

where N is the number of discharges attributed to the physician and Mphy was calculated in step 502.

In block 509, input the output dataset from step 220 and set the potential saving opportunity for the physicians included as 0 in block 507

In block 510, input the output dataset from step 222 and for the included DRGs, set the potential saving opportunity for the physicians included as 0 in block 507.

In block 511, within one DRG, the potential Saving Opportunity is summarized across physicians for each utilization dimension. In block 512, summarize the potential Saving Opportunity in each DRG.

In block 513, final output dataset with Total Saving Opportunity is created.

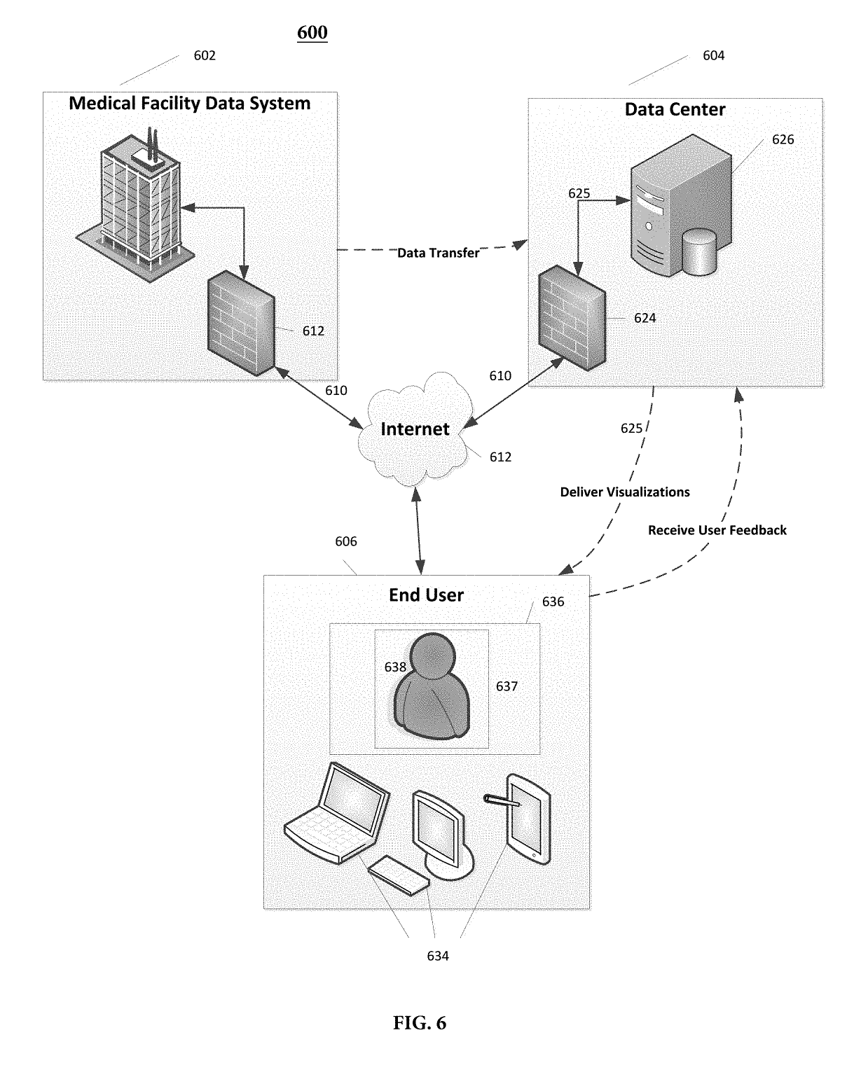

FIG. 6 depicts a schematic diagram of system 600 including the physical systems relationships between medical facility data system 602, data center 604 and end user 606 and the flow of information throughout the physical system. Clinical discharge data and financial data 610 flow from medical facility data system 602 to data center 604 via Internet 612. Data center 604 receives transferred clinical discharge data and financial data 610 at processor 624. For example, clinical discharge data and financial data 610 can be transferred by processor 612 using FTP data transfer to processor 624. Data center 604 processes transferred clinical discharge data and financial data 610. For example, processor 624 can generate visualized analysis reports 625. Database 626 can store information from processor 624 including visualized analysis reports 625. Processor 624 can send data such as visualized analysis reports 625 to end user 606 over internet 612. End user 606 can access visualized analysis reports 625 via user device 634. For example, user device 634 can include a desktop computer, laptop computer, tablet, or any like device. User device 634 can include user interface 636. User interface 636 can include display 637. Display 637 can display for example webpage 638.

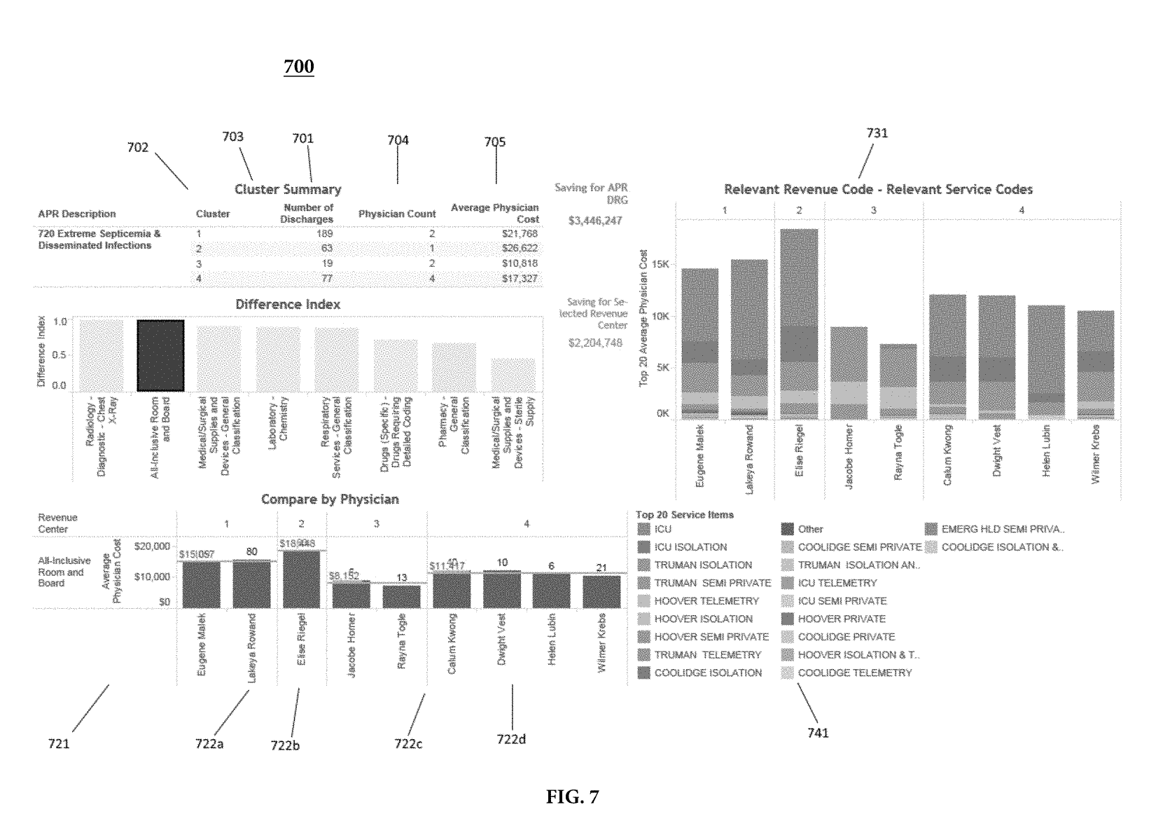

FIG. 7 is an example of interactive user dashboard for displaying potential cost savings based on the evaluated data which can be displayed as webpage 638 on display 637 shown in FIG. 6. The interactive user dashboard can be a webpage shown as “DRG dashboard” 700 as shown in FIG. 7. Dashboard 700 displays a cluster summary in portion 701. The cluster summary can include metrics for an APR-DRG of a cluster number 702, number of discharges 703, number of responsible physicians (RPs) 704 and average cost for the APR DRG for each cluster 705. Dashboard 700 displays a difference index summary in portion 711. The difference index summary can include metrics for a difference index of a utilization dimension directed to service items 712. Dashboard 700 can include a comparison of average costs for physician in portion 721. The comparison of average costs for physicians can be shown in respective portions 722a-722d based on assigned clusters. Dashboard 700 can display potential cost savings opportunities in portion 731 for each of the responsible physicians (RPs). Dashboard 700 can display the service items having the greatest potential for cost savings in portion 741.

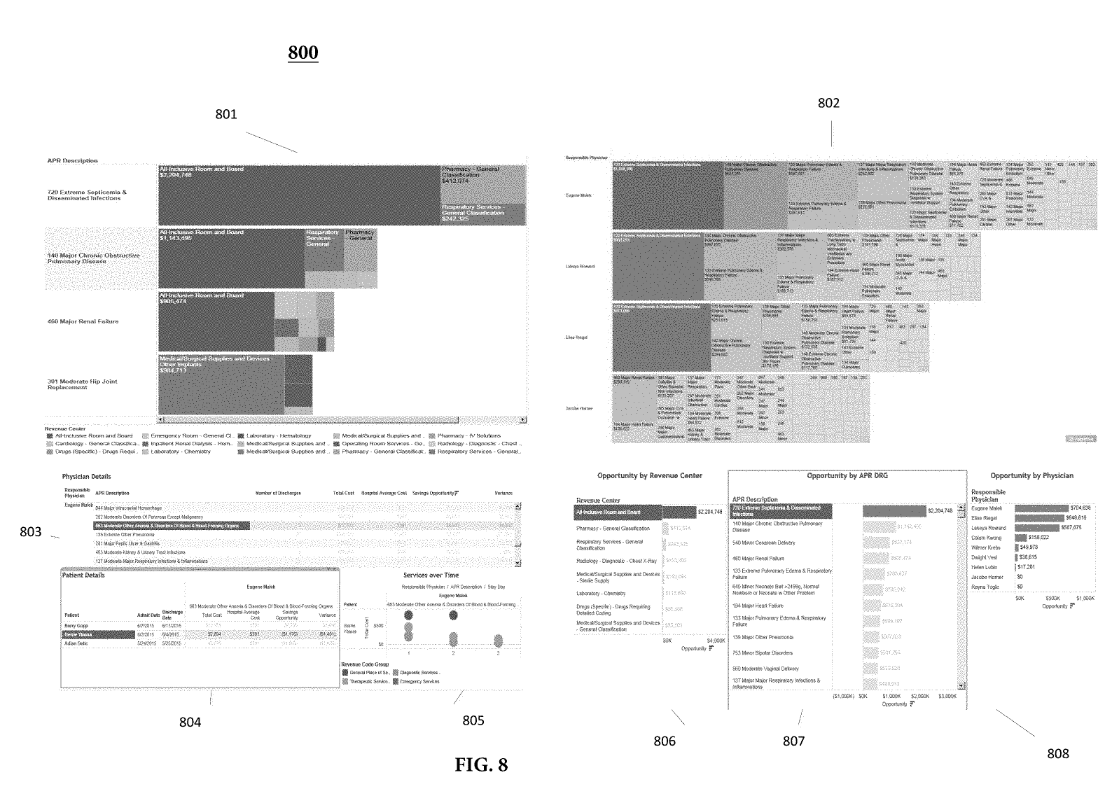

FIG. 8 is an example of interactive user dashboard 800 displaying potential cost savings based on the evaluated data. Interactive user dashboard 800 displays potential saving opportunity for the top APR DRGs by Revenue Centers in portion 801 and top Physicians by APR DRGs in portion 802. An example of an interactive user dashboard 800 displays cost and potential saving opportunity for physicians by APR DRGs in portion 803, discharge details in portion 804 and services utilized for treating the patients during length of stay in portion 805. Interactive user dashboard 800 can display a total saving opportunity by Revenue Center in portion 806 or by APR DRG in portion 807 or by physicians in portion 808 in an ad-hoc manner.

Although some embodiments herein refer to methods, it will be appreciated by one skilled in the art that they may also be embodied as a system or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects of the present invention may take the form of a computer program product embodied in one or more computer readable mediums having computer readable program code embodied thereon. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to CDs, DVDs, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks. The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A computer implemented method of optimization of medical resource utilization method comprising:
a. receiving by a computer inpatient data directed to cost information for one or more service items for a plurality of discharges;
b. for each discharge classifying by a computer said received inpatient data into Diagnosis Related Groups (“DRGs”);
c. generating by a computer a plurality of clusters of physicians based on the utilization for each of the Diagnosis Related Groups (“DRGs”);
d. for each utilization of the one or more service items with one of the Diagnosis Related Groups (“DRGs”), determining by a computer a difference index across the clusters based on utilization of the service item; and
e. inter-actively displaying on a computer display the difference index for each of the Diagnosis Related Groups (“DRGs”).

2. The computer implemented method of optimization of medical resource utilization method of claim 1 wherein the inpatient data is inpatient data for one hospital or inpatient data for a plurality of hospitals in a particular grouping.

3. The computer implemented method of optimization of medical resource utilization method of claim 1 wherein in step a. the cost information is adjusted to exclude or correct outlier cost to charge ratios (RCC) and a missing charge ratios RCC ratio to form a costed discharge record which is used in step b. as the received inpatient data.

4. The computer implemented method of optimization of medical resource utilization method of claim 1 wherein step b. further comprises classifying the Diagnosis related Groups with All Patient Refined Diagnosis Related Groups (APR DRGs).

5. The computer implemented method of optimization of medical resource utilization method of claim 4 wherein the physicians used in step c. are responsible physicians (RPs), the responsible physicians being determined by the steps of:
a. if the APR DRG is surgical, the responsible physician (RP) is a first entry in another physician location of the APR DRG and if the other physician location is empty, an attending physician is used as the responsible physician and if the attending physician is empty no responsible physician (RP) is assigned; or
b. if the APR DRG is not surgical, the responsible physician (RP) is an attending physician and if the attending physician is empty no responsible physician (RP) is assigned.

6. The computer implemented method of optimization of medical resource utilization of claim 5 wherein the responsible physician (RP) is assigned to a cluster in step. c if the number of cases that the responsible physician (RP) takes care for the same Diagnosis Related Group (DRG) is more than a threshold minimum cases number (nc) and if the number of responsible physicians (RPs) taking care of one the Diagnosis Related Group (DRG) is less than the threshold minimum physicians number (np).

7. The computer implemented method of optimization of medical resource utilization of claim 5 wherein for each DRG, in step c. the clusters are generated iteratively to determine an optimal number of clusters based on an overall R-Square value, wherein the responsible physicians (RPs) with similar costs across multiple dimensions within each DRG are assigned to the same cluster.

8. The computer implemented method of optimization of medical resource utilization of claim 5 wherein the Difference Index value is calculated for each utilization dimension within one DRG as
$$Difference Index = 1 - \text{?}$$
$$\text{?} \text{indicates text missing or illegible when filed}$$
in which N is the number of responsible physicians (RPs) for the Diagnosis Related Group (DRG), C is the number of clusters, within one of the Diagnosis Related Group (DRG) for one utilization dimension, Yi is the average cost for a responsible physician (RP) I, Y-bar is the mean of the average cost among all physicians for the Diagnosis Related Group (DRG); Yc-hat is the average physician cost in cluster.

9. The computer implemented method of optimization of medical resource utilization of claim 5 further comprising the step of:
determining a potential cost savings opportunity by optimizing resource utilization of the utilization dimension dependent on the difference index value.

10. The computer implemented method of optimization of medical resource utilization of claim 9 wherein the potential cost savings opportunity is a variance between an actual cost and an optimal cost based on the optimization of the resource utilization.

11. The computer implemented method of optimization of medical resource utilization of claim 9 further comprising interactively displaying the potential cost savings opportunities on the computer display.

12. A system for optimization of medical resource utilization method comprising:
a data center computer for receiving inpatient data directed to cost information for one or more service items for a plurality of discharge for each discharge classifying by a computer said received inpatient data into Diagnosis Related Groups (“DRGs”);
a computer for generating a plurality of clusters of physicians based on the utilization for each of the Diagnosis Related Groups (“DRGs”) for each utilization of the one or more service items with one of the Diagnosis Related Groups (“DRGs”), determining a difference index across the clusters based on utilization of the service item; and
a computer display for inter-actively displaying the difference index for each of the Diagnosis Related Groups (“DRGs”).

13. The system of claim 12 wherein the inpatient data is inpatient data for one hospital or inpatient data for a plurality of hospitals in a particular grouping.

14. The system of claim 12 wherein the cost information is adjusted to exclude or correct outlier cost to charge ratios (RCC) and a missing charge ratios RCC ratio to form a costed discharge record which is used as the received inpatient data.

15. The system of claim 12 wherein the Diagnosis related Groups are classified with All Patient Refined Diagnosis Related Groups (APR DRGs).

16. The system of claim 15 wherein the physicians are responsible physicians (RPs), the responsible physicians being determined by the steps of:
a. if the APR DRG is surgical, the responsible physician (RP) is a first entry in an other physician location of the APR DRG and if the other physician location is empty, an attending physician is used as the responsible physician and if the attending physician is empty no responsible physician (RP) is assigned; or
b. if the APR DRG is not surgical, the responsible physician (RP) is an attending physician and if the attending physician is empty no responsible physician (RP) is assigned.

17. The system of claim 16 wherein the responsible physician (RP) is assigned to a cluster if the number of cases that the responsible physician (RP) takes care for the same Diagnosis Related Group (DRG) is more than a threshold minimum cases number (nc) and if the number of responsible physicians (RPs) taking care of one the Diagnosis Related Group (DRG) is less than the threshold minimum physicians number (np).

18. The system of claim 16 wherein for each DRG, the clusters are generated iteratively to determine an optimal number of clusters based on an overall R-Square value, wherein the responsible physicians (RPs) with similar costs across multiple dimensions within each DRG are assigned to the same cluster and the Difference Index value is calculated for each utilization dimension within one DRG as
$$Difference Index = 1 - \text{?}$$
$$\text{?} \text{indicates text missing or illegible when filed}$$
in which N is the number of responsible physicians (RPs) for the Diagnosis Related Group (DRG), C is the number of clusters, within one of the Diagnosis Related Group (DRG) for one utilization dimension, Yi is the average cost for a responsible physician (RP) I, Y-bar is the mean of the average cost among all physicians for the Diagnosis Related Group (DRG); Yc-hat is the average physician cost in cluster.

19. The system of claim 18 wherein a potential cost savings opportunity is determined by optimizing resource utilization of the utilization dimension dependent on the difference index value which is a variance between an actual cost and an optimal cost based on the optimization of the resource utilization and the potential cost savings opportunities are interactively displayed on the computer display.

20. A computer program product comprising at least one non-transitory computer readable medium storing instructions translatable by a computer to perform:
a. receiving by a computer inpatient data directed to cost information for one or more service items for a plurality of discharges;
b. for each discharge classifying by a computer said received inpatient data into Diagnosis Related Groups (“DRGs”);
c. generating by a computer a plurality of clusters of physicians based on the utilization for each of the Diagnosis Related Groups (“DRGs”);
d. for each utilization of the one or more service items with one of the Diagnosis Related Groups (“DRGs”), determining by a computer a difference index across the clusters based on utilization of the service item; and
e. inter-actively displaying on a computer display the difference index for each of the Diagnosis Related Groups (“DRGs”).
